(19) United States
(12) Patent Application Publication
(10) Pub. No.: US 2021/0256113 A1
(43) Pub. Date: Aug. 19, 2021

(54) Blockchain Validation of Software

(71) Applicant: Bank of America Corporation, Charlotte, NC (US)

(72) Inventors: Christopher J. Stott, Charlotte, NC (US); Caleb G. Mann, Charlotte, NC (US)

(21) Appl. No.: 16/791,557

(22) Filed: Feb. 14, 2020

(51) Int. Cl. G06F 21/53; H04L 9/32; H04L 29/06; H04L 9/06

(52) U.S. Cl. CPC G06F 21/53; H04L 9/3236; H04L 63/02; G06F 2221/2149; H04L 9/0637; H04L 2209/38; H04L 63/123

(57) ABSTRACT

Aspects of the disclosure relate to validation of software by private and public blockchains. Hashes for known software are stored in a private blockchain. Hashes for unknown software are compared against the known hashes to determine if the software is known, malware free, and/or an authorized copy. Hashes for known good software and/or malware-containing software can be pre-seeded to the blockchains. Unknown software can be tested in sandboxes. Comparison results are stored in new blocks in the private chain and can be propagated out to the public chain anonymously without company attribution or software name disclosure. Validation servers can control the integrity of the blockchains. Updating blockchains may be controlled by requiring agreement of a majority of validation servers. Third parties can access the public chain to evaluate unknown software that they receive to determine if the software is malware free and/or an authorized copy.

### TECHNICAL FIELD OF DISCLOSURE

Aspects of the disclosure relate to information security. In particular, one or more aspects of the disclosure pertain to authentication and validation of software (i.e., collectively, applications, executables, code, snippets, scripts, data, files, etc.) to detect and protect against malicious software (i.e., malware), and to prevent against unauthorized modifications or unauthorized copies of software or portions thereof.

### BACKGROUND

Malware is software that is specifically designed to gain access to or damage a computer. There are various types of malware, including spyware, ransomware, viruses, worms, Trojan horses, adware, or any type of malicious code that infiltrates a computer.

Generally, software is considered malware based on the intent of the creator rather than its actual features. Malware creation is on the rise due to money that can be made through organized Internet crime, and it can be used for vandalism and destruction of targeted machines. Today, much of malware is created to make a profit from forced advertising (adware), stealing sensitive information (spyware or corporate espionage), spreading email spam (zombie computers), or extorting money (ransomware). Additionally, some malware may be used in conjunction with hacking or anarchist activities intended to cause data destruction or business disruption.

Various factors can make computers more vulnerable to malware attacks, including defects in the operating system (OS) design, all of the computers on a network running the same OS, giving users too many permissions, or just because a computer runs on a particular common operating system thus making it more prone to a wide variety of potential attacks or threat vectors.

In the past, the best protection from malware—whether ransomware, bots, browser hijackers, or other malicious software—was the usual, preventive advice: be careful about what email attachments you open, be cautious when surfing by staying away from suspicious websites, and install and maintain an updated, quality antivirus program.

Such prior art attempts to provide information security are insufficient. Relying on third parties, such as antivirus companies, to identify malware and provide security against it, can take a long time for the companies to detect and even longer for them to develop solutions to the detected threat vectors. Further, it may require public notification of a problem, which would undermine confidence in the company that was attacked or in the commercial software that the company uses or sells. In addition, reliance on a third party is problematic as it presents a single point of failure in a defense architecture. Moreover, the prior art attempts are unsuitable for detecting unauthorized copies of software, such as through digital rights management or the like, since unauthorized copies of software may not have malware inserted into it.

### SUMMARY

Aspects of the disclosure provide effective, efficient, scalable, and convenient technical solutions that address and overcome the technical problems associated with information security, high-speed detection of malware and protection against it, anonymous communication to the industry or government of malware threat vectors, safe testing of unknown applications or untrusted code in sandboxes and/or virtual machines, and detection of unauthorized copies of software or portions thereof, by use of cryptographic hash functions in blockchain-based security solutions. In doing so, various technical advantages may be realized. For example, one technical advantage of a blockchain-based, open-ledger is that all software validations and transactional entries in a blockchain ledger are always correct and valid due to the enforcement of all new transactions by validation servers including, for example, existing nodes of one or more blockchains. A further advantage is that all entries in the blockchain-based, open-ledger are shared and open to all participants of the blockchain(s), which guarantees auditing of each transaction. As yet a further advantage, entries in a blockchain-based, open-ledger are immutable, and thus cannot be modified once entered. Still another advantage is the ability to anonymously notify the industry or government of threat vectors without having to publicly disclose that a particular company or the name of commercial software application that has been targeted. By integrating blockchain-based, open-ledger systems with information security for software protection including through the use of sandbox(es) and/or virtual machine(s), these and/or other technical advantages may be realized in the context of rapid protection against malware, safe testing of unknown or questionable applications, detection of unauthorized copies or modifications of software, and other benefits as detailed herein.

In accordance with one or more embodiments of the disclosure, validation of software can be performed in conjunction with private and public blockchains. Hashes for known software can be stored in a private blockchain. Hashes for unknown software can be compared against the known hashes to determine if the software is known, malware free, and/or an authorized copy. Hashes for known good software and/or malware-containing software can be pre-seeded to the blockchains. Unknown software can be tested in sandboxes and/or virtual machines. Comparison results can be stored in new blocks in the private chain and can be propagated out to the public chain anonymously, without company attribution or software name disclosure, in order to share with the industry, the government, or other authorized parties information regarding known good software and software known to contain malware and/or otherwise be an unauthorized copy. Various full computing nodes, lightweight computing nodes, and/or validation servers can control the integrity of the blockchains. Updating blockchains may be controlled by requiring agreement of a majority of validation servers and/or applicable nodes. Third parties can access the public chain to evaluate unknown software that they receive to determine if the software is malware free and/or an authorized copy.

In some embodiments, a software validation computing platform can be coupled to an anonymous public distributed ledger having a first public block and a second public block. The computing platform can include: at least one processor; a communication interface communicatively coupled to the at least one processor and the anonymous public distributed ledger; a private distributed ledger communicatively coupled to the communication interface; and memory, storing platform computer-readable instructions that, when executed by the at least one processor, cause the computing platform to perform various functions. An authentic cryptographic hash of authentic software known to be malware free can be generated. The authentic cryptographic hash corresponding to the authentic software and first indicia sufficient to identify the authentic software can be stored in a first private block in the distributed ledger and can be anonymously stored in the first public block in the anonymous public distributed ledger. Unknown software to be evaluated can be received from a data source and stored in a quarantine sector of the memory. The authentic cryptographic hash can be loaded from the first private block in the private distributed ledger to a first sector in the memory. A test cryptographic hash of the unknown software can be generated and stored in a second sector of the memory. The authentic cryptographic hash for the authentic software in the first sector of the memory can be compared to the test cryptographic hash for the unknown software in the second sector of the memory. If the authentic cryptographic hash and the test cryptographic hash match, the unknown software can be copied from the quarantine sector of the memory to an authorized sector of the memory and can be executed. If the authentic cryptographic hash and the test cryptographic hash do not match, the unknown software can be copied from the quarantine sector of the memory to a sandbox and executed therein in order to determine whether the unknown software contains malware. If the unknown software is malware free, the test cryptographic hash for the unknown software can be stored in a second private block in the private distributed ledger along with a certified event record that the unknown software is malware free and second indicia sufficient to identify the unknown software, and can be stored anonymously in the second block in the anonymous public distributed ledger. The unknown software can be copied from the quarantine sector of the memory to the authorized sector of the memory and executed therein. If the unknown software contains malware, the test cryptographic hash for the unknown software can be stored in the second private block in the private distributed ledger along with an uncertified event record that the unknown software contains malware and the second indicia sufficient to identify the unknown software, and can be stored anonymously in the second public block in the anonymous public distributed ledger Execution of the unknown software containing malware can be prevented outside of the quarantine sector of the memory.

In some embodiments, a software validation computing platform may contain a plurality of validation servers each having: at least one validation processor; a validation communication interface communicatively coupled to the at least one validation processor and the private distributed ledger; and a validation memory storing validation computer-readable instructions that, when executed by the at least one validation processor, cause the validation software to perform various functions. The at least one validation processor can independently validate the test cryptographic hash prior to the anonymous storing of the test cryptographic hash in the second public block of the anonymous public distributed ledger. The at least one validation processor in response to the independent validation, can determine whether a majority of the plurality of validation servers agree that the test cryptographic hash is valid. If the plurality of validation servers agrees that the test cryptographic hash is valid, the test cryptographic hash for the unknown software can be stored in a second private block in the private distributed ledger along with a certified event record that the unknown software is malware free and second indicia sufficient to identify the unknown software and can be anonymously stored in the second public block in the anonymous public distributed ledger. If the plurality of validation servers is not in agreement that the test cryptographic has is valid, the test cryptographic hash can be disregarded.

In some embodiments, comparison, by the at least one processor, of the authentic cryptographic hash for the authentic software in the first sector of the memory to the test cryptographic hash for the unknown software in the second sector of the memory can determine if the unknown software is an unauthorized copy of the authentic software.

In some embodiments, a firewall may protect the private distributed ledger from the anonymous distributed ledger, may protect the private distributed ledger and at least one of the plurality of validation servers from the anonymous public distributed ledger, and/or protect the private distributed ledger and at least one of the plurality of validation servers from the anonymous public distributed ledger and at least another of the plurality of validation servers.

In some embodiments, the plurality of validation servers can be full node computing devices, lightweight computing devices, and/or a combination of full node and lightweight node computing devices.

In some embodiments, a sandbox may be used to safely execute and test unknown software. Alternatively, a virtual machine may be used to safely execute and test unknown software.

In some embodiments, the test cryptographic hash for the unknown software is stored in the second private block in the private distributed ledger along with either the certified event record or the uncertified event record, the second indicia sufficient to identify the unknown software, and a generic numeric representation of the private distributed ledger.

In some embodiments, the test cryptographic hash for the unknown software is anonymously stored in the second public block in the anonymous public distributed ledger along with either the certified event record or the uncertified event record, the second indicia sufficient to identify the unknown software, and a generic numeric representation of the anonymous public distributed ledger.

In some embodiments, a generic numeric representation of the private distributed ledger and/or the anonymous public distributed ledger can comprise 256-bit hexadecimal numbers.

In some embodiments, one or more non-transitory computer-readable media can store instructions that, when executed by a software validation computing platform, can cause the platform to perform various functions. A plurality of processors can be communicatively coupled to at least one communication interface, which is communicatively coupled to said one or more computer-readable media, to a private distributed ledger, and to an anonymous public ledger. A first of the plurality of processors can generate an authentic cryptographic hash of authentic software known to be malware free. The authentic cryptographic hash corresponding to the authentic software and first indicia sufficient to identify the authentic software can be stored in a first private block in the private distributed ledger. The plurality of processors can validate the authentic cryptographic hash. The plurality of processors can determine whether a first majority of the plurality of processors agree that the authentic cryptographic hash is valid. If valid, the authentic cryptographic hash for the authentic software can be stored in a first private block in the private distributed ledger along with a first certified event record that the authentic software is malware free and first indicia sufficient to identify the authentic software, and can be anonymously stored in a first public block in the anonymous public distributed ledger. Unknown software to be evaluated can be received from a data source and stored in a quarantine sector of said one or more computer-readable media. One of the plurality of processors can generate a test cryptographic hash of the unknown software. The authentic cryptographic hash can be compared with the test cryptographic hash. If the authentic cryptographic hash and the test cryptographic hash match, the unknown software can be copied from the quarantine sector of the at least one computer-readable media to an authorized sector of the at least one computer-readable media and authorized for execution. If the authentic cryptographic hash and the test cryptographic hash do not match, the unknown software can be copied from the quarantine sector of the at least one computer-readable media to a sandbox and executed therein. A determination can be made as to whether the unknown software contains malware. If the unknown software is malware free, the test cryptographic hash for the unknown software can be stored in a second private block in the private distributed ledger along with a second certified event record that the unknown software is malware free and second indicia sufficient to identify the unknown software. The test cryptographic hash can be validated and, if a plurality of processors agree that the test cryptographic hash is valid, the test cryptographic hash for the unknown software can be stored in a second private block in the private distributed ledger along with the second certified event record that the authentic software is malware free and second indicia sufficient to identify the unknown software, and can be anonymously stored in the second public block in the anonymously public distributed ledger. If the unknown software contains malware, the plurality of processors can validate the test cryptographic hash and determine whether a third majority of the plurality of processors agree that the test cryptographic hash is valid. If valid, the test cryptographic hash for the unknown software can be stored in the second private block in the private distributed ledger along with an uncertified event record that the unknown software contains malware and the second indicia sufficient to identify the unknown software and also anonymously stored in the second public block in the anonymous public distributed ledger.

In some embodiments, a dual blockchain software validation method can be used to validate software. A software validation platform can store, in a first private block in a private distributed ledger, an authentic cryptographic hash corresponding to authentic software known to be malware free and first indicia sufficient to identify the authentic software. The software validation platform can store, in a first public block in an anonymous public distributed ledger, the authentic cryptographic hash corresponding to the authentic software and the first indicia sufficient to identify the authentic software. The software validation platform can receive from a data source, unknown software to be evaluated. The unknown software can be stored in a quarantine sector of memory in the software validation platform. The software validation platform can hash a test cryptographic hash for the unknown software and compare the test cryptographic hash to the authentic cryptographic hash. If the authentic cryptographic hash and the test cryptographic hash match, the software validation platform can copy, from the quarantine sector of the memory to an authorized sector of the memory, the unknown software and can authorize execution of the unknown software. If the authentic cryptographic hash and the test cryptographic hash do not match, the software validation platform can copy, from the quarantine sector of to a sandbox, the unknown software, and can execute the unknown software in the sandbox. The software validation platform can determine whether the unknown software contains malware. If the unknown software is malware free, a plurality of processors in the software validation platform can validate the test cryptographic hash and determine whether a first majority of the plurality of processors agree that the test cryptographic hash is valid. If valid, the test cryptographic hash for the unknown software can be stored in a second private block in the private distributed ledger along with a second certified event record that the unknown software is malware free and second indicia sufficient to identify the unknown software, and can be anonymously stored in the second public block in the anonymous public distributed ledger. The unknown software can be copied from the quarantine sector of the memory to the authorized sector of the memory and authorized for execution. If the unknown software contains malware, the plurality of processors can validate the test cryptographic hash and determine whether a second majority of the plurality of processors agree that the test cryptographic hash is valid. If valid, the test cryptographic hash for the unknown software can be stored in the second private block in the private distributed ledger along with an uncertified event record that the unknown software is contains malware and the second indicia sufficient to identify the unknown software, and can be anonymously stored in the second public block in the anonymous public distributed ledger. Software containing malware can be deleted from the sandbox when testing is complete.

In some embodiments, the comparison of the test cryptographic hash to the authentic cryptographic hash can determine if the unknown software is an unauthorized copy of the authentic software.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative example of a centralized computer system in accordance with one or more illustrative aspects described herein;

FIG. 2 depicts an illustrative example of a decentralized P2P computer system that may be used in accordance with one or more illustrative aspects described herein;

FIG. 3A depicts an illustrative example of a full node computing device that may be used in accordance with one or more illustrative aspects described herein;

FIG. 3B depicts an illustrative example of a lightweight node computing device that may be used in accordance with one or more illustrative aspects described herein;

FIG. 4 depicts an illustrative computing environment for validation of software based on the authentication in accordance with one or more example embodiments;

FIG. 5 depicts an illustrative functional block diagram for an overall architecture for software validation in accordance with one or more example embodiments; and

FIG. 6 depicts a sample flow diagram illustrating actions that can be performed by or on workstation(s), validation servers, highspeed private chain(s), anonymous public chain(s), as well as interactions with regulators or other third parties, in accordance with one or more embodiments.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is noted that various connections between elements are discussed in the following description. It is noted that these connections are general and, unless specified otherwise, may be direct or indirect, wired or wireless, and that the specification is not intended to be limiting in this respect.

As a general introduction to the subject matter described in more detail below, aspects described herein are directed towards use of cryptographic hash functions in blockchain-based security solutions for high-speed software validation, malware protection, safe testing in sandbox(es) or virtual machine(s) of unknown or untrusted applications or code, copy detection, anonymous sharing of data, and reporting to and/or monitoring by one or more industries, companies, or governmental agencies of results of any one or more of the foregoing. In some aspects, the scheme described herein employs decentralized computing system(s) for creating and managing one or more blockchain(s) and implementing safe testing by use of sandbox(es) and/or virtual machine(s).

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

As used herein, a “sector” is broadly defined as subdivision(s) or block(s) of memory and is not limited to the minimum storage unit of a hard drive or other computer-readable medium. Further, the sector may have a fixed size or may be variable.

The disclosure provided herein is described, at least in part, in relation to a decentralized peer-to-peer (e.g., P2P) system specialized for the purpose of managing one or more blockchain(s). The decentralized P2P system may be comprised of computing device(s) that are distributed in multiple locations across a geographical area as opposed to a single location such as a business or company. The computing device(s) forming the decentralized P2P system may operate with each other to manage blockchain(s) (such as with Stellar, Ripple, or the like), which may be data structure(s) used to store information related to the decentralized P2P system, perform cryptographic hash function(s) on applications or code, and/or utilize sandbox(es) or virtual machines for testing and authentication purposes. And, blockchain(s) may be a chronological linkage of data elements (e.g., blocks), which store data records relating to the decentralized computing system.

A user may access the decentralized P2P system through a specialized “wallet” that serves to uniquely identify the user and enable the user to perform functions related to the decentralized P2P network. (As used herein, a “user” may be a person, a company, and/or an authorized user or employee at a company.) Through the wallet, the user may be able to hold or control software, software validations, software versioning, cryptographic hashes, code repositories, identifications of known threat vectors, data or information, sandbox(es), virtual machine(s), tokens, funds, or any other asset (collectively, “asset”) associated with the decentralized P2P system. Furthermore, the user may be able to use the wallet to request performance of network-specific functions related to any asset associated with the decentralized P2P system such as software validation, sandboxing, software testing, software versioning, copy detection, malware detection or remediation, reporting or disclosure of information, fund, token, and/or asset transfers. The various computing device(s) forming the decentralized P2P computing system may operate as a team to perform network-specific functions requested by the user. In performing the network-specific functions, the various computing device(s) may produce blocks that store the data generated during the performance of the network-specific functions and may add the blocks to one or more applicable blockchain(s). After the block has been added to the blockchain, the wallet associated with the user may indicate that the requested network-specific function has been performed. If desired, a separate blockchain may be instituted for each software application that has been tested or for which good/bad hashes have been generated. Alternatively, the same blockchain may be used for a plurality of applications and/or hashes. Similarly, a separate blockchain may be used to monitor and track each threat vector or malware or, alternatively, a single blockchain may be used for some or all threat vectors or malware.

For example, a user may have a wallet associated with the decentralized P2P system that reflects that the user is a developer of a software application (or version thereof) and that an authorized and malware-free version of the software has a certain cryptographic hash, which can be considered to be a “good” hash. The user may provide a request to the decentralized P2P system to publish the cryptographic hash for the software application to enable the user as well as other third parties to generate their own cryptographic hash of their copy of the software to verify that it is malware-free and/or an authorized copy of the software. Determination of whether the software is malware free and/or is an authorized copy can be determined by performing a cryptographic hash on a user or company's copy of the software and comparing that hash with the hash published on the blockchain. If the hash for the authorized and malware free version of the original software matches the hash of the software being investigated, the parties know that the software under consideration is also authorized and/or malware free. Similarly, if hashes do not match, the bad hash is essentially a watermark indicating that there is a problem with the software such as it potentially contains malware, has been modified, or an authorized copy of an application or portion thereof has been made.

In doing the foregoing, one or more block(s) may be created by the various computing device(s) of the decentralized P2P computing system. The block may store data indicating any of the foregoing information. The various computing device(s) may add the block to one or more blockchain(s) for authentication and comparison purposes.

In more detail, the decentralized P2P system may be specialized for the purpose of managing a distributed ledger, such as a private blockchain or a public blockchain, through the implementation of digital cryptographic hash functions, consensus algorithms, digital signature information, and network-specific protocols and commands (individually and/or collectively referenced herein as cryptographic hashes or the like). The decentralized P2P system (e.g., decentralized system) may be comprised of decentralized system infrastructure consisting of a plurality of computing device(s), either of a heterogeneous or homogenous type, which serve as network nodes (e.g., full nodes and/or lightweight nodes) to create and sustain a decentralized P2P network (e.g., decentralized network). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions of the decentralized network, such as software validation, malware-free certifications, authorized copy or transactions or operations, at least a portion of the full nodes forming the decentralized network may execute the one or more cryptographic hash functions, consensus algorithms, and network-specific protocols to register a requested network function on the blockchain. In some instances, a plurality of network function requests may be broadcasted across at least a portion of the full nodes of the decentralized network, aggregated through execution of the one or more digital cryptographic hash functions, and validated by performance of the one or more consensus algorithms to generate a single work unit (e.g., block), which may be added in a time-based, chronological manner to the blockchain through performance of network-specific protocols.

While in practice the term “blockchain” may hold a variety of contextually derived meanings, the term blockchain, as used herein, refers to a concatenation of sequentially dependent data elements (e.g., blocks) acting as a data ledger that stores records relating to a decentralized computing system. Such data records may be related to those used by a particular entity or enterprise, such as a financial institution, and/or may be associated with a particular application and/or use case including, but not limited to, software validation, software versioning, malware-free certifications, copyright protection, authorized/unauthorized copy detection, digital content storage and delivery, entity authentication and authorization, digital identity, marketplace creation and operation, internet of things (e.g., IoT), prediction platforms, computing platforms, among others. A “private blockchain” (or semi-private blockchain) may refer to a blockchain of a decentralized private system in which only authorized computing device(s) are permitted to act as nodes in a decentralized private network and have access to the private blockchain on in which only certain companies, such as members of an industry or trade organization, and/or appropriate governmental entities have access. In some instances, the private blockchain may be viewable and/or accessible by authorized computing device(s) which are not participating as nodes within the decentralized private network, but still have proper credentials. A “public blockchain” may refer to a blockchain of a decentralized public system in which any computing device(s) may be permitted to act as nodes in a decentralized public network and have access to the public blockchain. In some instances, the public blockchain may be viewable and/or accessible by computing device(s) which are not participating as nodes within the decentralized public network. Access to and modification of blockchain(s) may be partially or wholly anonymous if desired.

Further, a “full node” or “full node computing device,” as used herein, may describe computing device(s) in a decentralized system which operate to create and maintain a decentralized network, execute requested network functions, and maintain inter-nodal agreement as to the state of the blockchain. In order to perform such responsibilities, a computing device operating as a full node in the decentralized system may have a complete replica or copy of one or more blockchain(s) stored in memory, as well as executable instructions for the execution of hash functions, consensus algorithms, digital signature information, network protocols, and network commands. A “lightweight node,” “light node,” “lightweight node computing device,” or “light node computing device” may refer to a computing device in a decentralized system, which operates to request performance of network functions within a decentralized network but without the capacity to execute requested network functions and maintain inter-nodal agreement as to the state of the blockchain(s). As such, a computing device operating as a lightweight node in the decentralized system may have a partial replica or copy of the blockchain(s). In some instances, network functions requested by lightweight nodes to be performed by the decentralized network may also be able to be requested by full nodes in the decentralized system.

“Network functions” and/or “network-specific functions,” as described herein, may relate to functions that are able to be performed by nodes of a decentralized P2P network. In some arrangements, the data generated in performing network-specific functions may or may not be stored on blockchain(s) associated with the decentralized P2P network. Examples of network functions may include software validation, software publishing, copy detection, software certifications, malware-free certifications, malware tracking, threat vector monitoring, software versioning, event reporting, event management, smart contracts, transactions, or the like among others.

In one or more aspects of the disclosure, a “digital cryptographic hash function” or “cryptographic hash” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPoS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network.

As will be described in further detail below, a decentralized P2P system implementing blockchain data structure(s) may provide solutions to technological problems existing in current centralized system constructs with traditional data storage arrangements. For example, conventional data storage arrangements that use a central data authority have a single point of failure (namely, the central storage location) which, if compromised by a malicious attacker, can lead to data tampering, unauthorized data disclosure, unauthorized copying, and exploitation and/or loss of operative control of the processes performed by or software monitored or controlled by the centralized system. The implementation of blockchain data structure(s) in a decentralized P2P system acts as a safeguard against unreliable and/or malicious nodes acting in the decentralized P2P network to undermine the work efforts of the other nodes, e.g., by providing byzantine fault tolerance within the network.

Computing Architectures

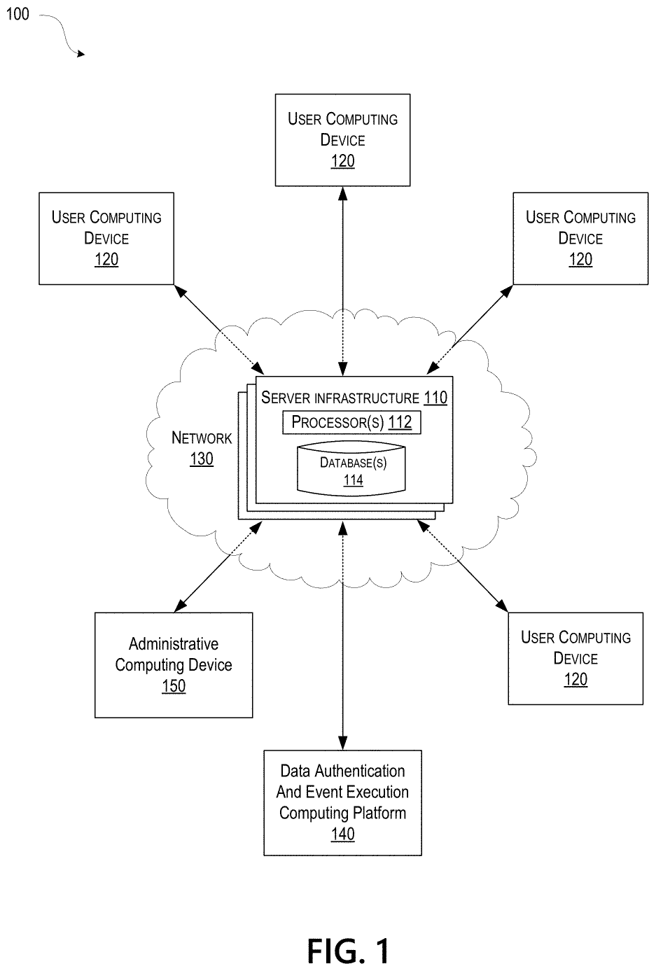

FIG. 1 depicts an illustrative example of centralized computer system 100 in accordance with one or more illustrative aspects described herein. Centralized computer system 100 may comprise one or more computing device(s) including, for example, server infrastructure 110, user computing device(s) 120, administrative computing device(s) 150, and/or data event and execution platform(s) 140. Each of user computing device(s) 120, administrative computing device(s) 150, and data event and execution platform(s) 140 may be configured to communicate with server infrastructure 110 through network 130. In some arrangements, centralized computer system 100 may include additional computing device(s), networks, and/or platforms that are not depicted in FIG. 1, which also may be configured to interact with server infrastructure 110 and, in some instances, user computing device(s) 120, administrative computing device 150, and data event and execution platform 140.

As described below in more detail, each user computing device 120, administrative computing device 150, and/or data event and execution platform 140 may be either full node computing device(s) such as 210A-210F, lightweight node computing device(s) such as 250A or 250B, or may collectively be a combination of the foregoing.

Server infrastructure 110 may be associated with a distinct entity such as a company, school, government, and the like, and may comprise one or more personal computer(s), server computer(s), hand-held or laptop device(s), multiprocessor system(s), microprocessor-based system(s), set top box(es), programmable consumer electronic device(s), network personal computer(s) (PC), minicomputer(s), mainframe computer(s), distributed computing environment(s), and the like. Server infrastructure 110 may include computing hardware and software that may host various data and applications for performing tasks of the centralized entity and interacting with user computing device(s) 120, administrative computing device(s) 150, and/or data event and execution platform(s) 140, as well as other computing devices. For example, each of the computing device(s) comprising server infrastructure 110 may include at least one or more processors 112 and one or more databases 114, which may be stored in memory of the one or more computing device(s) of server infrastructure 110. Through execution of computer-readable instructions stored in memory, the computing device(s) of server infrastructure 110 may be configured to perform functions of the centralized entity and store the data generated during the performance of such functions in databases 114 or other data stores (not shown).

In some arrangements, server infrastructure 110 may include and/or be part of enterprise information technology infrastructure and may host a plurality of enterprise applications, enterprise databases, and/or other enterprise resources. Such applications may be executed on one or more computing device(s) included in server infrastructure 110 using distributed computing technology and/or the like. In some instances, server infrastructure 110 may include a relatively large number of servers that may support operations of a particular enterprise or organization, such as a financial institution. Server infrastructure 110, in this embodiment, may generate a single centralized ledger for data received from the various user computing device(s) 120, which may be stored in databases 114 or other data stores (not shown).

Each of the user computing device(s) 120, administrative computing device(s) 150, and/or data event and execution platform(s) 140 may be configured to interact with server infrastructure 110 through network 130. In some instances, one or more of the user computing device(s) 120, administrative computing device(s) 150, and data event and execution platform(s) 140 may be configured to receive and transmit information corresponding to system requests through particular channels and/or representations of software or data associated with server infrastructure 110. The system requests provided by user computing device(s) 120, administrative computing device(s) 150, and/or data event and execution platform(s) 140 may initiate the performance of particular computational functions such as data and/or file transfers at server infrastructure 110, software validation, software versioning, malware detection, reporting, copy detection, among others. In such instances, the one or more of the user computing device(s) may be internal computing device(s) associated with the particular entity corresponding to server infrastructure 110 and/or may be external computing device(s) which may or may not be associated with the particular entity.

As stated above, centralized computer system 100 also may include one or more networks, which may interconnect one or more of server infrastructure 110 and one or more user computing device(s) 120, administrative computing device(s) 150, and/or data event and execution platform(s) 140. For example, centralized computer system 100 may include network 130. Network 130 may include one or more sub-networks (e.g., local area networks (LANs), wide area networks (WANs), or the like). Furthermore, centralized computer system 100 may include a local network configured to interconnect each of the computing device(s) comprising server infrastructure 110.

Furthermore, in some embodiments, centralized computer system 100 may include a plurality of computer systems arranged in an operative networked communication with one another through a network, which may interface with server infrastructure 110, user computing device(s) 120, administrative computing device(s) 150, and/or data event and execution platform(s) 140, and network 130. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between device(s) on the network.

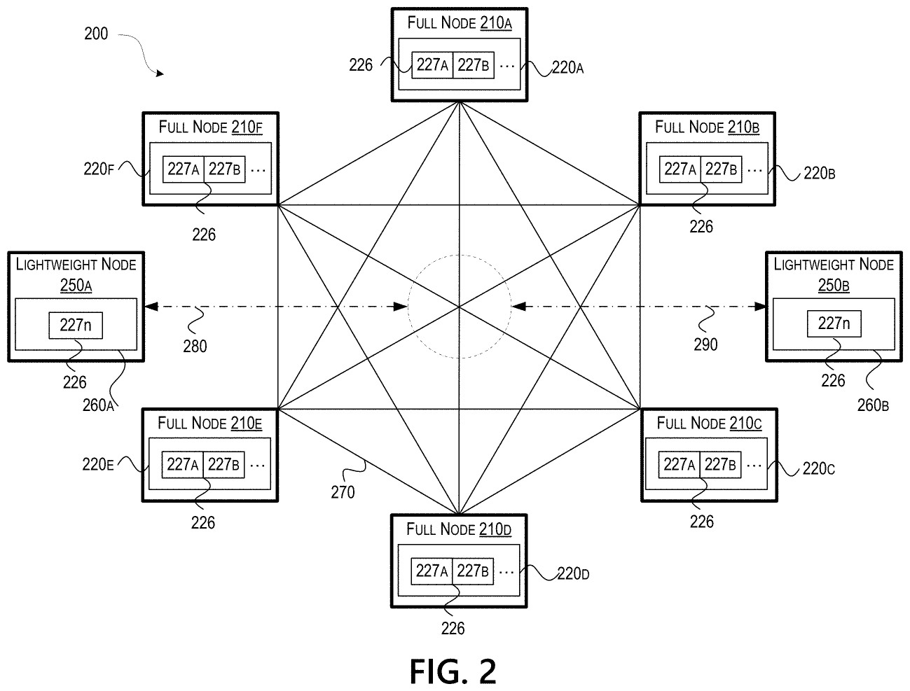

In some embodiments, centralized computer system 100 may include a plurality of computer systems or device(s) that contain one or more blockchain(s) 226 or sandbox(es) 230, such as depicted in FIGS. 2, 3A, 3B, and 5, and described in more detail below. Blockchain(s) 226 and sandboxes 230 may be stored in, implemented in, and/or accessed by one or more of any computing device(s) including user computing device(s) 120, administrative computing device 150, and/or data authentication and event execution computing platform 140, and/or server infrastructure 110.

As used herein, sandbox(es), such as sandbox(es)/virtual machine(s) 230, are testing environment(s) that isolate untested applications and/or untested code changes and outright experimentation from the production environment or repository. Sandbox(es) are programs that allow safe execution of programs inside the box, without affecting the system, while a virtual machine is a type of sandbox that allows safe execution of an OS (system) in addition to one or more applications inside an already installed system (without affecting the host system as well). As such, sandbox(es) and virtual machine(s) are used interchangeably sometimes herein.

Sandboxing protects “live” clients, servers and their data, vetted source code distributions, and other collections of code, data and/or content, proprietary or public, from changes that could be damaging such as, for example, to a mission-critical system or which could simply be difficult to revert, regardless of the intent of the author of those changes. Sandboxes 230 replicate at least the minimal functionality needed to accurately test the programs or other code under development (e.g. usage of the same environment variables as, or access to an identical database to that used by, the stable prior implementation intended to be modified; there are many other possibilities, as the specific functionality needs vary widely with the nature of the code and the application[s] for which it is intended).

The concept of sandbox 230 (sometimes also called a working directory, a test server or development server) provides the capability to examine software in a safe environment prior to distribution to other machines or execution in a particular computing device. Only after an application or code has been tested in sandbox(es) 230 and verified as authentic, malware free, authorized, etc., would the software be executed, distributed, and/or deployed outside of the protected memory area.

By further analogy, the term “sandbox” can also be applied herein in the context of computing and networking to other temporary or indefinite isolation areas, such as security sandboxes, which prevent incoming applications and/or data from affecting a “live” system (or aspects thereof) unless/until defined requirements or criteria have been met.

In the centralized computer system 100 described in regard to FIG. 1, server infrastructure 110 may serve as a central authority which manages at least a portion of the computing data and actions performed in relation to the particular entity associated with server infrastructure 110. As such, server infrastructure 110 of centralized computer system 100 provides a single point of failure which, if compromised by a malicious attacker, can lead to data tampering, unauthorized data disclosure, and exploitation and/or loss of operative control of the processes performed by the server infrastructure 110 in relation to the particular entity associated with server infrastructure 110. In such a centralized construct in which a single point of failure (e.g., server infrastructure 110) is created, significant technological problems arise regarding maintenance of operation and data control, as well as preservation of data integrity. As will be described in further detail below in regard to FIG. 2, such technological problems existing in centralized computing arrangements may be solved by a decentralized P2P system implementing blockchain data structure(s), even wholly within the server infrastructure 110.

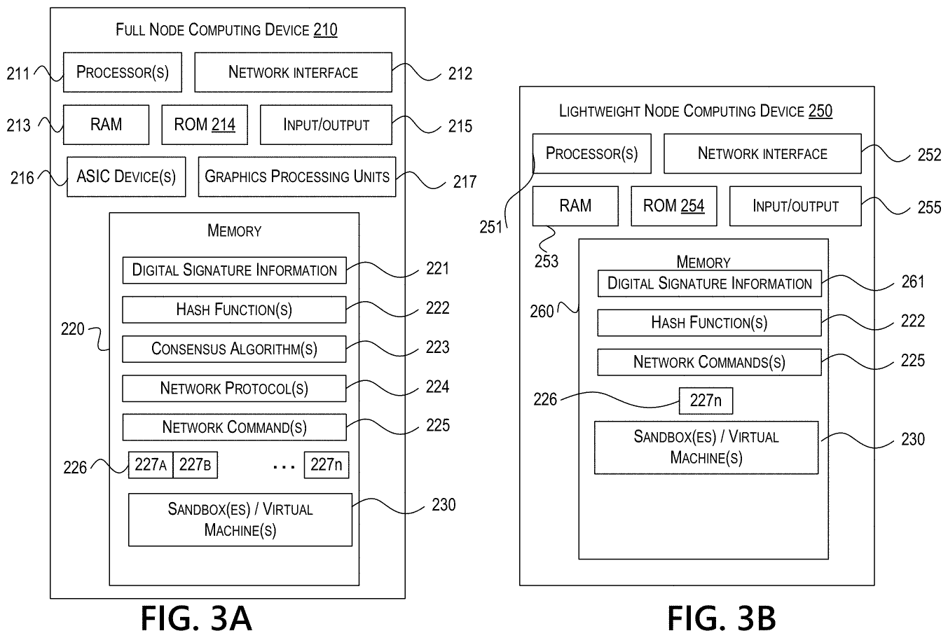

FIG. 2 depicts an illustrative example of decentralized P2P computer system 200 that may be used in accordance with one or more illustrative aspects described herein. Decentralized P2P computer system 200 may include a plurality of full node computing device(s) 210A, 210B, 210C, 210D, 210E, and 210F and lightweight node computing device(s) 250A and 250B, which may be respectively similar to full node computing device 210 described in regard to FIG. 3A and lightweight node computing device 250 described in regard to FIG. 3B. While a particular number of full node computing device(s) and lightweight node computing device(s) are depicted in FIG. 2, it should be understood that a number of full node computing device(s) and/or lightweight node computing device(s) greater or less than that of the depicted full node computing device(s) and lightweight node computing device(s) may be included in decentralized P2P computer system 200. Accordingly, any additional full node computing device(s) and/or lightweight node computing device(s) may respectively perform in the manner described below in regard to full node computing device(s) 210A-210F and lightweight node computing device(s) 250A and 250B in decentralized P2P computer system 200.

Each of full node computing device(s) 210A-210F may operate in concert to create and maintain decentralized P2P network 270 of decentralized P2P computer system 200. In creating decentralized P2P network 270 of decentralized P2P computer system 200, processors, ASIC device(s), and/or graphics processing units (e.g., GPUs) of each full node computing device 210A-210F may execute network protocols which may cause each full node computing device 210A-210F to form a communicative arrangement with the other full node computing device(s) 210A-210F in decentralized P2P computer system 200. Furthermore, the execution of network protocols by the processors, ASIC device(s), and/or graphics processing units (e.g., GPUs) of full node computing device(s) 210A-210F may cause full node computing device(s) 210A-210F to execute network functions related to blockchain 226 and thereby maintain decentralized P2P network 270. Each full node computing device 210A-210F may contain its own sandbox(es) and/or virtual machines 230 if desired. Alternatively, sandbox(es) and/or virtual machines may be located entirely with a server in order to facilitate central authentication, authorization, testing, or the like in a client-server architecture.

Lightweight node computing device(s) 250A and 250B may request execution of network functions related to blockchain 226 in decentralized P2P network 270. In order to request execution of network functions, processors of lightweight node computing device(s) 250A and 250B may execute network commands to broadcast the network functions to decentralized P2P network 270 comprising full node computing device(s) 210A-210F. Each lightweight node computing device 210A-210F may contain its own sandbox(es) 230 if desired.

For example, lightweight node computing device 250A may request execution of a network function related to blockchain 226 in decentralized P2P network 270, which may entail a data transfer from a private/public key associated with lightweight node computing device 250A to a private/public key associated with lightweight node 250B. In doing so, processors of lightweight node computing device 250A may execute network commands to broadcast a network function request 280 or communication to decentralized P2P network 270. Network function request 280 may further include the public key associated with lightweight node computing device 250B. Processors of lightweight node computing device 250A may execute digital signature algorithms to digitally sign network function request 280 with the private key associated with lightweight node computing device 250A.

At decentralized P2P network 270, network function request 280 may be broadcasted to each of full node computing device(s) 210A-210F through execution of network protocols by full node computing device(s) 210A-210F. In order to execute network function request 280 and maintain inter-nodal agreement as to the state of blockchain 226, processors, ASIC device(s), and/or GPUs of full node computing device(s) 210A-210F may execute network protocols to receive the broadcast of the network function through a decentralized P2P network 270 and from lightweight node computing device 250A. Processors, ASIC device(s), and/or GPUs of full node computing device(s) 210A-210F may execute hash functions to generate a digest of network function request 280. The resultant digest of network function request 280, in turn, may be hashed with the block hash of the most immediately preceding block of blockchain 226. Processors, ASIC device(s), and/or GPUs of full node computing device(s) 210A-210F may execute consensus algorithms to identify a numerical value (e.g., nonce) corresponding to the particular executed consensus algorithm and related to the digest that combines the digest of the network function request 280 and the block hash of the most immediately preceding block of blockchain 226.

For example, in embodiments in which the consensus algorithm is proof of work (e.g., PoW), processors, ASIC device(s), and/or GPUs of full node computing device(s) 210A-210F may perform a plurality of hashing operations to identify a nonce that, when hashed with the digest that combines the digest of the network function request 280 and the block hash of the most immediately preceding block of blockchain 226, produces a hash of a predetermined alphanumerical format. Such a predetermined alphanumerical format may include a predetermined number of consecutive alphanumerical characters at a predetermined position within the resultant digest that combines the nonce, digest of the network function request 280, and block hash of the most immediately preceding block of blockchain 226.

In embodiments in which the consensus algorithm is proof of stake (e.g., PoS), a private key associated with one of full node computing device(s) 210A-210F may be pseudo-randomly selected, based on software, malware, or other data or information associated with the public keys of full node computing device(s) 210A-210F, to serve as the nonce. For example, through execution of the PoS consensus algorithm, full node computing device(s) 210A-210F are entered into a lottery in which the odds of winning are proportional to information associated with the public key of each of full node computing device(s) 210A-210F, wherein a larger amount or value corresponds to a higher probability to win the lottery. The PoS consensus algorithm may cause a full node computing device from full node computing device(s) 210A-210F to be selected, and the public key of the selected full node computing device to be used as the nonce.

In embodiments in which the consensus algorithm is delegated proof of stake (e.g., DPoS), a group of delegates are chosen from full node computing device(s) 210A-210F by each of computing device(s) 210A-210F, wherein full node computing device(s) 210A-210F are allowed to vote on delegates based on one or more variables associated with the respective public keys. Full node computing device(s) 210A-210F, however, may not vote for themselves to be delegates. Once the group of delegates are chosen, the group of delegates from full node computing device(s) 210A-210F select a public key associated with one of full node computing device(s) 210A-210F to serve as the nonce. Again, each of the delegates are prohibited from selecting themselves and their respective public key from serving as the nonce.

In embodiments in which the consensus algorithm is practical byzantine fault tolerance algorithm (e.g., PBFT), each of full node computing device(s) 210A-210F are associated with a particular status and/or ongoing specific information associated with the respective public key of the full node computing devices. Each of full node computing device(s) 210A-210F receive a message through decentralized P2P network 270 based on network protocols. Based on the received message and particular status and/or ongoing specific information, each of full node computing device(s) 210A-210F perform computational tasks and transmit a response to the tasks to each of the other full node computing device(s) 210A-210F. A public key associated with a particular full node computing device from full node computing device(s) 210A-210F is selected by each of full node computing device(s) 210A-210F based on the response of the particular full node computing device best fulfilling criteria determined based on the network protocols.

The identification of the nonce enables processors, ASIC device(s), and/or GPUs of the full node computing device from full node computing device(s) 210A-210F to create a new block with a block header (e.g., block hash), which is a digest that combines the digest of the network function request 280, the block hash of the most immediately preceding block, and the identified nonce. Processors, ASIC device(s), and/or GPUs of the full node computing device from full node computing device(s) 210A-210F may execute network protocols to add the new block to blockchain 226 and broadcast the new block to the other full node computing device(s) in the decentralized P2P network 270. In some arrangements, the new block may also be time-stamped at a time corresponding to the addition to blockchain 226. Furthermore, as a reward for adding the new block to blockchain 226, the full node computing device from full node computing device(s) 210A-210F may be allowed, per the network protocols, to increase a variable associated with itself by a predetermined amount. In some arrangements, each of full node computing device(s) 210A-210F may receive an equal portion of the variable specified by lightweight node computing device 260A for executing network function request 280. After the new block has been added to blockchain 226, network function request 280 may be considered to be executed and the data transfer from the private/public key associated with lightweight node computing device 250A to the private/public key associated with lightweight node 250B may be registered.

As stated above, in some arrangements, a plurality of network function requests may be broadcasted across decentralized network P2P network 270. Processors, ASIC device(s), and/or GPUs of full node computing device(s) 210A-210F may execute network protocols to receive broadcast of each of the network functions, including network function request 280, through decentralized P2P network 270 and from the requesting entities, including lightweight node computing device 250A. Processors, ASIC device(s), and/or GPUs of full node computing device(s) 210A-210F may execute hash functions to generate a hash tree (e.g., Merkle tree) of the requested network functions, which culminates in a single digest (e.g., root digest, root hash, and the like) that comprises the digests of each of the requested network functions, including network function request 280. The root digest of the requested network function, in turn, may be hashed with the block hash of the most immediately preceding block of blockchain 226. Processors, ASIC device(s), and/or GPUs of full node computing device(s) 210A-210B may execute consensus algorithms in the manner described above to identify a nonce corresponding to the particular executed consensus algorithm and related to the digest that combines the root digest of the requested network functions and the block hash of the most immediately preceding block of blockchain 226.

While the description provided above is made in relation to network functions or transactions involving lightweight node computing device 250A and lightweight node computing device 250B, it is to be understood that they are not limited to lightweight node computing device 250A and lightweight node computing device 250B, but rather may be made across any of the full node computing device(s) and/or lightweight node computing device(s) in decentralized P2P system 200.

For another example, lightweight node computing device 250B may request a network function related to blockchain 226 in decentralized P2P network 270, which may facilitate a dual data transfer between a private/public key associated with lightweight node computing device 250B and a private/public key associated lightweight node computing device 250A. Processors of lightweight node computing device 250B may execute network commands to broadcast network function request 290 to decentralized P2P network 270. Network function request 290 may include details about an event or data transfer, as well as any related or associated variable to full node computing device(s) 210A-210F of decentralized P2P network 270 for executing network function request 290. Network function request 290 may further include the public key associated therewith. Processors of lightweight node computing device 250B may execute digital signature algorithms to digitally sign software, versions, malware-free certifications, authorized transfers or purchase relating to network function request 290 with the private key associated with lightweight node computing device 250B.

At decentralized P2P network 270, network function request 290 may be broadcasted to each of full node computing device(s) 210A-210F through execution of network protocols by full node computing device(s) 210A-210F. In order to execute network function request 290 and maintain inter-nodal agreement as to the state of blockchain 226, processors, ASIC device(s), and/or GPUs of full node computing device(s) 210A-210F may execute network protocols to receive broadcast of the network function through a decentralized P2P network 270 and from lightweight node computing device 250B. Processors, ASIC device(s), and/or GPUs of full node computing device(s) 210A-210F may execute hash functions to generate a digest of network function request 290. The resultant digest of network function request 290, in turn, may be hashed with the block hash of the most immediately preceding block of blockchain 226. Processors, ASIC device(s), and/or GPUs of full node computing device(s) 210A-210F may execute consensus algorithms to identify a nonce corresponding to the particular executed consensus algorithm and related to the digest that combines the digest of network function request 290 and the block hash of the most immediately preceding block of blockchain 226.

The identification of the nonce enables processors, ASIC device(s), and/or GPUs of the full node computing device from full node computing device(s) 210A-210F to create a new block with a block header (e.g., block hash), which is a digest that combines network function request 290, the block hash of the most immediately preceding block, and the identified nonce. Processors, ASIC device(s), and/or GPUs of the full node computing device from full node computing device(s) 210A-210F may execute network protocols to add the new block to blockchain 226 and broadcast the new block to the other full node computing device(s) in the decentralized P2P network 270. In some arrangements, the new block may also be time-stamped at a time corresponding to the addition to blockchain 226. Furthermore, as a reward for adding the new block to blockchain 226, the full node computing device from full node computing device(s) 210A-210F may, per the network protocols, increase a variable associated with itself by a predetermined amount. In some arrangements, each of full node computing device(s) 210A-210F may receive an equal portion of the variable specified by lightweight node computing device 260A for executing network function request 290. After the new block has been added to blockchain 226, request 290 may be considered to be executed and the private/public key associated with lightweight node computing device 250B to the private/public key associated with the smart contract may be registered.

In some instances, a smart contract or other event may be configured to hold the data transfer from the private/public key associated with lightweight node computing device 250B until fulfillment of certain predetermined criteria hardcoded is achieved. The smart contract or event ay be configured such that it serves as an intermediate arbiter between entities within the decentralized P2P network 270 and may specify details of a dual data transfer between entities.

Lightweight node computing device 250A may also request a network function related to blockchain 226 in decentralized P2P network 270, which may conclude the dual data transfer between a private/public key associated lightweight node computing device 250A and a private/public key associated with lightweight node computing device 250B. Processors of lightweight node computing device 250A may execute network commands to broadcast the smart contract operation network function request to decentralized P2P network 270. The network function request may include details about the data transfer, as well as a variable to full node computing device(s) 210A-210F of decentralized P2P network 270 for executing the network function request. The network function request may further include the public key associated therewith. Processors of lightweight node computing device 250A may execute digital signature algorithms to digitally sign the network function request with the private key associated with lightweight node computing device 250A.

At decentralized P2P network 270, the smart network function request may be broadcasted to each of full node computing device(s) 210A-210F through execution of network protocols by full node computing device(s) 210A-210F. In order to execute the network function request and maintain inter-nodal agreement as to the state of blockchain 226, processors, ASIC device(s), and/or GPUs of full node computing device(s) 210A-210F may execute network protocols to receive broadcast of the network function through a decentralized P2P network 270 and from lightweight node computing device 250A. Processors, ASIC device(s), and/or GPUs of full node computing device(s) 210A-210F may execute hash functions to generate a digest of the network function request. The resultant digest of the network function request, in turn, may be hashed with the block hash of the most immediately preceding block of blockchain 226. Processors, ASIC device(s), and/or GPUs of full node computing device(s) 210A-210F may execute consensus algorithms to identify a nonce corresponding to the particular executed consensus algorithm and related to the digest that combines the digest of the network function request and the block hash of the most immediately preceding block of blockchain 226.

While the description provided above was made in relation to lightweight node computing device 250A and lightweight node computing device 250B, it should be understood that any of the full node computing device(s) and lightweight node computing device(s) in decentralized system 200 may participate in various events, network-related functions, certifications, or analyses. Furthermore, it should be understood that the network functions may be able to fulfill dual data transfers in the manner described above across a plurality of entities.

In comparison to the centralized computing system 100 described in regard to FIG. 1, decentralized P2P computer system 200 may provide technological advantages. For example, by distributing storage of blockchain 226 across multiple full node computing device(s) 210A-210F, decentralized P2P computer system 200 may not provide a single point of failure for malicious attack. In the event that any of the full node computing device(s) 210A-210F are compromised by a malicious attacker, decentralized P2P computer system 200 may continue to operate unabated as data storage of blockchain 226 and network processes are not controlled by a singular entity such as server infrastructure 110 of centralized computing system 100.

Furthermore, by utilizing blockchain data structure 226, decentralized P2P system 200 may provide technological improvements to conventional decentralized P2P systems in regard to byzantine fault tolerance stemming from an unreliable and/or malicious full node acting in decentralized P2P network 270 to undermine the work efforts of the other nodes. For example, in coordinating action between full node computing device(s) 210A-210F in relation to a similar computational task (e.g., consensus algorithm), a malicious node would need to have computational power greater than the combined computational power of each of the other full node computing device(s) in decentralized P2P network 270 to identify the nonce and thereby be able to modify blockchain 226. As such, the likelihood that a malicious node could subvert decentralized P2P network 270 and enter falsified data into blockchain 270 is inversely proportional to the total computational power of decentralized P2P system 200. Therefore, the greater the total computational power of decentralized P2P system 200, the less likely that a malicious node could subvert decentralized P2P network 270 and undermine blockchain 226.

FIG. 3A depicts an illustrative example of a full node computing device 210 that may be used in accordance with one or more illustrative aspects described herein. Full node computing device 210 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, full node computing device 210 may be configured to operate in a decentralized P2P network and may request execution of network functions and/or to execute requested network functions and maintain inter-nodal agreement as to the state of a blockchain of the decentralized P2P network.

Full node computing device 210 may include one or more processors 211, which control overall operation, at least in part, of full node computing device 210. Full node computing device 210 may further include random access memory (RAM) 213, read only memory (ROM) 214, network interface 212, input/output interfaces 215 (e.g., keyboard, mouse, display, printer), and memory 220. Input/output (I/O) 215 may include a variety of interface units and drives for reading, writing, displaying, and/or printing data or files. In some arrangements, full node computing device 210 may further comprise specialized hardware components such as application-specific integrated circuit (e.g., ASIC) device(s) 216 and/or graphics processing units (e.g., GPUs) 217. Such specialized hardware components may be used by full node computing device 210 in performing one or more of the processes involved in the execution of requested network functions and maintenance of inter-nodal agreement as to the state of a blockchain. Full node computing device 210 may further store in memory 220 operating system software for controlling overall operation of the full node computing device 210, control logic for instructing full node computing device 210 to perform aspects described herein, and other application software providing secondary, support, and/or other functionality which may or might not be used in conjunction with aspects described herein.

Memory 220 may also store data and/or computer executable instructions used in performance of one or more aspects described herein. For example, memory 220 may store digital signature information 221 and one or more hash functions 222, consensus algorithms 223, network protocols 224, and network commands 225. In some arrangements, digital signature information 221, hash functions 222, and/or network commands 225 may comprise a wallet of full node computing device 210. Memory 220 may further store blockchain 226. Each of digital signature information 221, hash functions 222, consensus algorithms 223, network protocols 224, and network commands 225 may be used and/or executed by one or more processors 211, ASIC device(s) 216, and/or GPUs 217 of full node computing device 210 to create and maintain a decentralized P2P network, request execution of network functions, and/or execute requested network functions and maintain inter-nodal agreement as to the state of blockchain 226.

For example, in order to create and maintain a decentralized P2P network, processors 211, ASIC device(s) 216, and/or GPUs 217 of full node computing device 210 may execute network protocols 225. Execution of network protocols 225 may cause full node computing device 210 to form a communicative arrangement with other full node computing device(s) and thereby create a decentralized P2P network. Furthermore, the execution of network protocols 225 may cause full node computing device 210 to maintain the decentralized P2P network through the performance of computational tasks related to the execution of network requests related to a blockchain such as blockchain 226. As will be described in detail below, the execution of such computational tasks (e.g., hash functions 222, consensus algorithms 223, and the like) may cause full node computing device 210 to maintain inter-nodal agreement as to the state of a blockchain with other full node computing device(s) comprising the decentralized P2P network.

In order to request execution of network functions, processors 211, ASIC device(s) 216, and/or GPUs 217 of full node computing device 210 may execute network commands 225 to broadcast the network function to a decentralized P2P network comprising a plurality of full nodes and/or lightweight nodes. The request may be digitally signed by full node computing device 210 with usage of the private/public key information and through execution of the digital signature algorithms of digital signature information 221.

In order to execute requested network functions and maintain inter-nodal agreement as to the state of a blockchain, processors 211, ASIC device(s) 216, and/or GPUs 217 of full node computing device 210 may execute network protocols 224 to receive a broadcast of a requested network function through a decentralized P2P network and from a requesting entity such as a full node or lightweight node. Processors 211, ASIC device(s) 216, and/or GPUs 217 of full node computing device 210 may execute hash functions 222 to generate a digest of the requested network function. The resultant digest of the requested network function, in turn, may be hashed with the block hash of the most immediately preceding block of the blockchain. As will be described in further detail below, processors 211, ASIC device(s) 216, and/or GPUs 217 of full node computing device 210 may execute consensus algorithms 223 to identify a numerical value (e.g., nonce) corresponding to the particular executed consensus algorithm and related to the digest that combines the digest of the requested network function and the block hash of the most immediately preceding block of the blockchain. The identification of the numerical value enables processors 211, ASIC device(s) 216, and/or GPUs 217 of full node computing device 210 to create a new block with a block header (e.g., block hash), which is a digest that combines the digest of the requested network function, the block hash of the most immediately preceding block, and the identified nonce. Processors 211, ASIC device(s) 216, and/or GPUs 217 of full node computing device 210 may add the new block to the blockchain based on network protocols 224 and broadcast the new block to the other nodes in the decentralized P2P network.

As stated above, in some arrangements, a plurality of network function requests may be broadcasted across the decentralized network P2P network. Processors 211, ASIC device(s) 216, and/or GPUs 217 of full node computing device 210 may execute network protocols 224 to receive broadcast of each of the network functions through the decentralized P2P network and from the requesting entities. Processors 211, ASIC device(s) 216, and/or GPUs 217 of full node computing device 210 may execute hash functions 222 to generate a hash tree (e.g., Merkle tree) of the requested network functions, which culminates in a single digest (e.g., root digest, root hash, and the like) that comprises the digests of each of the requested network functions. The root digest of the requested network function, in turn, may be hashed with the block hash of the most immediately preceding block of the blockchain. Processors 211, ASIC device(s) 216, and/or GPUs 217 of full node computing device 210 may execute consensus algorithms 223 to identify a numerical value (e.g., nonce) corresponding to the particular executed consensus algorithm and related to the digest that combines the root digest of the requested network functions and the block hash of the most immediately preceding block of the blockchain. The identification of the numerical value enables processors 211, ASIC device(s) 216, and/or GPUs 217 of full node computing device 210 to create a new block with a block header (e.g., block hash), which is a digest that combines the root digest of the requested network functions, the block hash of the most immediately preceding block, and the identified nonce. Processors 211, ASIC device(s) 216, and/or GPUs 217 of full node computing device 210 may add the new block to the blockchain based on network protocols 224 and broadcast the new block to the other nodes in the decentralized P2P network.

Furthermore, memory 220 of full node computing device 210 may store blockchain 226. Blockchain 226 may include a blocks 227A, 227B, 227C, . . . 227n, wherein block 227A represents the first block (e.g., genesis block) of blockchain 226 and block 227n represents the most immediate block of blockchain 226. As such, the blockchain 226, which may be a replica or copy of the blockchain of the decentralized P2P network in which full node computing device 210 operates, may be a full or complete copy of the blockchain of the decentralized P2P network. Each of the blocks within blockchain 226 may include information corresponding to the one or more network functions executed by the decentralized P2P network. As such, blockchain 226 as stored in memory 220 of full node computing device 210 may comprise the totality of network functions executed by the decentralized network. Moreover, memory 220 of full node computing device 210 may store and/or implemented its own sandbox(es) 230 if desired.

FIG. 3B depicts an illustrative example of a lightweight node computing device 250 that may be used in accordance with one or more illustrative aspects described herein. Lightweight node computing device 250 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, lightweight node computing device 250 may operate in a decentralized P2P network and may be configured to request execution of network functions through the decentralized P2P network. As such, lightweight node computing device 250 may be different from full node computing device 210 in that it is not configured to execute network functions and/or operate to maintain a blockchain of a decentralized P2P network. In other aspects, lightweight node computing device 250 may have substantially the same physical configuration as full node computing device 210, but configured with different programs, software.

Lightweight node computing device 250 may include one or more processors 251, which control overall operation of lightweight node computing device 250. Lightweight node computing device 250 may further include random access memory (RAM) 253, read only memory (ROM) 254, network interface 252, input/output interfaces 255 (e.g., keyboard, mouse, display, printer), and memory 260. Input/output (I/O) 255 may include a variety of interface units and drives for reading, writing, displaying, and/or printing data or files. Lightweight node computing device 250 may store in memory 260 operating system software for controlling overall operation of the lightweight node computing device 250, control logic for instructing lightweight node computing device 250 to perform aspects described herein, and other application software providing secondary, support, and/or other functionality which may or might not be used in conjunction with aspects described herein. Moreover, memory 220 of lightweight node computing device 210 may store and/or implemented its own sandbox(es) 230 if desired.

In comparison to full node computing device 210, lightweight node computing device 250 might not include, in some instances, specialized hardware such as ASIC device(s) 216 and/or GPUs 217. Such is the case because lightweight node computing device 250 might not be configured to execute network functions and/or operate to maintain a blockchain of a decentralized P2P network as is full node computing device 210. However, in certain arrangements, lightweight node computing device 250 may include such specialized hardware. Optionally, lightweight node computing device 210 may not store and/or implement its own sandbox 230 as desired.

Memory 260 of lightweight node computing device 250 may also store data and/or computer executable instructions used in performance of one or more aspects described herein. For example, memory 260 may store digital signature information 261 and one or more hash functions 222 and network commands 225. In some arrangements, digital signature information 261, hash functions 222, and/or network commands 225 may comprise a wallet of lightweight node computing device 250. Each of hash functions 222 and network commands 225 stored in memory 260 of lightweight node computing device 250 may be respectively similar and/or identical to hash functions 222 network commands 225 stored in memory 220 of full node computing device 210.

In regard to the digital signature information, each of digital signature information 261 stored in memory 260 of lightweight node computing device 250 and digital signature information 221 stored in memory 220 of full node computing device 210 may comprise similar and/or identical digital signature algorithms. However, the private/public key information of digital signature information 261 stored in memory 260 of lightweight node computing device 250 may be different from that of the private/public key information of digital signature information 221 stored in memory 220 of full node computing device 210. Furthermore, the private/public key information of each node, whether full or lightweight, in a decentralized P2P computing network may be unique to that particular node. For example, a first node in a decentralized P2P computing network may have first private/public key information, a second node may have second private/public key information, a third node may have third private/public key information, and so on, wherein each of the private/public key information is unique to the particular node. As such, the private/public key information may serve as a unique identifier for the nodes in a decentralized P2P computing network.

Each of digital signature information 261, hash functions 222, and network commands 225 may be used and/or executed by one or more processors 251 of lightweight node computing device 250 to request execution of network functions in a decentralized P2P network. For example, in order to request execution of network functions, processors 251 of lightweight node computing device 250 may execute network commands 225 to broadcast the network function to a decentralized P2P network comprising a plurality of full nodes and/or lightweight nodes. The request may be digitally signed by lightweight node computing device 250 with usage of the private/public key information and through execution of the digital signature algorithms of digital signature information 261.

Furthermore, memory 260 of lightweight node computing device 250 may store blockchain 226. Blockchain 226 stored in memory 260 of lightweight node computing device 250 may include at least block 227n, wherein block 227n represents the most immediate block of blockchain 226. As such, the blockchain 226, which may be a replica or copy of the blockchain of the decentralized P2P network in which lightweight node computing device 250 operates, may be a partial or incomplete copy of the blockchain of the decentralized P2P network. In some instances, however, blockchain 226 may include a blocks 227A, 227B, 227C, . . . 227n, wherein block 227A represents the first block (e.g., genesis block) of blockchain 226 and block 227n represents the most immediate block of blockchain 226. As such, the blockchain 226 may be a full or complete copy of the blockchain of the decentralized P2P network. Each of the blocks within blockchain 226 may include information corresponding to the one or more network functions executed by the decentralized P2P network.

User Data Authentication and Event Execution

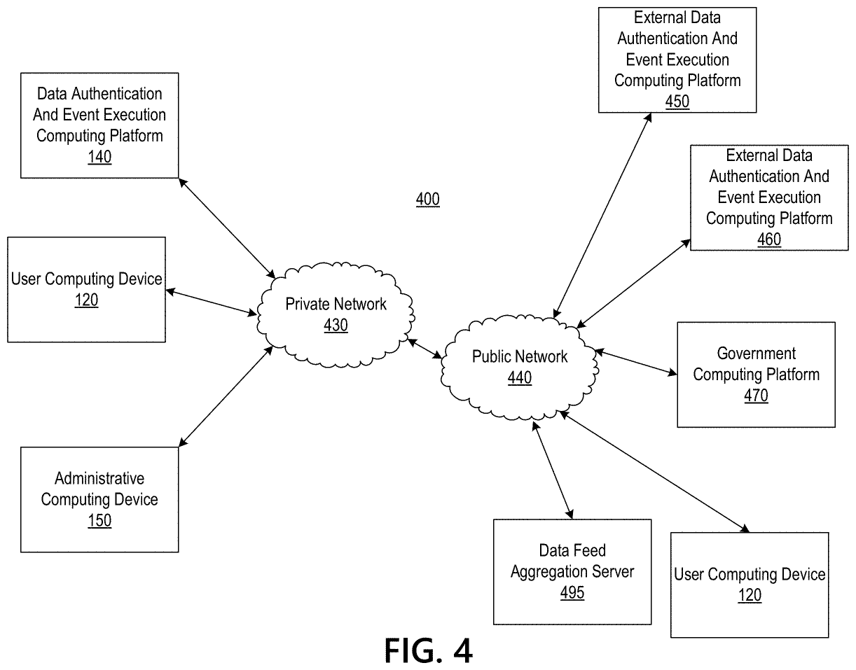

FIG. 4 depicts an illustrative computing environment for authentication, authorization, certification, testing, reporting, and/or monitoring of user data and execution of events in accordance with one or more example embodiments. Referring to FIG. 4, computing environment 400 may include one or more computer systems, one or more computer networks, and/or other computing infrastructure. For example, computing environment 400 may include one or more internal data authentication and event execution computing platform(s) 140, administrative computing device(s) 150 or other internal or external user computing device(s) 120, a private network 430, a public network 440, one or more external data authentication and event execution computing platforms 450, 460, a government computing and/or monitoring platform 470 (including government or regulatory platform(s) or device(s)), and/or data feed aggregation server(s) 495.

In addition to performing specific functions detailed further below, each of one or more internal data authentication and event execution computing platforms 140, an administrative computing device 150 or other internal or external user computing device(s) 120, a private network 430, a public network 440, one or more external data authentication and event execution computing platforms 450, 460 a government computing platform 470, and/or data feed aggregation server 495 may function as full node computing device(s) 210 or as lightweight node computing device(s) 250 to authenticate various types of software or user data, add the authenticated data to a given user's blockchain (e.g., after cryptographically hashing the authenticated data), maintain a copy of the current state of the user's blockchain, execute events related to the authenticated data or software, communicate with other network nodes functioning as lightweight node computing device(s) 250, and implement one or more sandbox(es) 230. In one embodiment, data authentication and event execution computing platform(s) may function as a full node computing device 210 and administrative computing device(s) 150, one or more external data authentication and event execution computing platform(s) 450, 460, government computing platform 470, user computing device(s) 120, and/or data feed aggregation server 495 may function as lightweight node computing device(s) 250.

In other embodiments, more than one platform in computing environment 400 may function as a full node computing device 210. For example, data authentication and event execution computing platform(s) 140, administrative computing device 150, one or more external data authentication and event execution computing platforms 450, 460, government computing platform 470, user computing device 120, and/or data feed aggregation server 495 may all function as full node computing device(s) 210 in computing environment 400. In this example, data authentication and event execution computing platform 140, administrative computing device 150, one or more external data authentication and event execution computing platforms 450, 460, government computing platform 470, user computing device 120, and/or data feed aggregation server 495 may all operate to create and maintain a decentralized network, execute requested network functions related to user data authentication and event execution, testing, certification, reporting or otherwise maintain inter-nodal agreement as to the state of the user's blockchain, and execute events related to the user data. In order to perform these functions, one or more of the foregoing may all have a complete replica or copy of the user's blockchain stored in memory, as well as executable instructions for the execution of hash functions, consensus algorithms, digital signature information, network protocols, and network commands. One or more of the foregoing may also have its own sandbox, access to a shared sandbox, and/or access to test results from a central sandboxing authority.

When functioning as a lightweight node 250, device(s) and platforms may request performance of network functions (e.g., to have user data authenticated onto the user's blockchain, to have operations executed after authentication of the underlying user data, and the like). However, when functioning as a lightweight node 250, platforms and device(s) may not have the capacity to execute the network functions and maintain inter-nodal agreement as to the state of any given user's blockchain.

As discussed in greater detail below, data authentication and event execution computing platform(s) 140 may include one or more computing device(s) configured to perform one or more of the functions described herein. For example, data authentication and event execution computing platform(s) 140 may include one or more computers (e.g., laptop computers, desktop computers, servers, server blades, or the like) that are configured to orchestrate data authentication, authorization, certification or other operations across multiple computer systems and device(s) in computing environment 400.

Administrative computing device(s) 150 may be a desktop computer, laptop computer, workstation, or other computing device(s) configured to be used by administrative users or IT individuals, such as a network administrator associated with an organization operating data authentication and event execution computing platform 140.

External data authentication and event execution platforms 450, 460 and government computing platform 470 may include one or more computing device(s) configured to host software, perform software validations, detect and/or report threat vector information, issue certifications, etc. (which may or may not be provided by an organization different from the organization operating data authentication and event execution computing platform(s) 140).

User computing device(s) 120 may be a desktop computer, laptop computer, workstation, mobile device, or other computing device(s) that is configured to be used by a user to access services in environment 400.

Data feed aggregation server(s) 495 may include one or more computing device(s) configured to aggregate data feeds such as, for examples, hashes for known applications, approved code, malware-free certifications, distribution of information, reporting of malware, and the like, from various source systems. In some instances, data feed aggregation server 495 may communicate and/or otherwise provide the aggregated data feed to one or more destination systems, such as data authentication and event execution computing platform(s) 140, so as to enable one or more functions provided by data authentication and event execution computing platform 140 (e.g., such as data authentication using blockchain technology and event execution). In some instances, the aggregated data feed may be communicated by data feed aggregation server 495 to data authentication and event execution computing platform(s) 140 or other device(s) and/or platform(s) via a secure and/or encrypted communications link established between data authentication and event execution computing platform(s) 140 or the like to data feed aggregation server(s) 495. In other instances, data feeds may be separately communicated from each of platforms and others to platform 140 or others via multiple secure and/or encrypted communications links established between various platforms or device.

Computing environment 400 also may include one or more networks, which may interconnect one or more of data authentication and event execution computing platform(s) 140, administrative computing device(s) 150, external data authentication and event execution platforms 450, 460, government platform 470, user computing device(s) 120, and data feed aggregation server(s) 495. For example, computing environment 100 may include private network 430, which may be owned and/or operated by a specific organization and/or which may interconnect one or more systems and/or other device(s) associated with the specific organization. For example, data authentication and event execution computing platform(s) 140 and administrative computing device(s) 150 may be owned and/or operated by a specific organization, such as a financial institution, and private network 430 may interconnect data authentication and event execution computing platform(s) 140, administrative computing device(s) 150, and one or more other systems and/or device(s) associated with the organization. Additionally, private network 430 may connect (e.g., via one or more firewalls) to one or more external networks not associated with the organization, such as public network 440. Public network 440 may, for instance, include the internet and may connect various systems and/or device(s) not associated with the organization operating private network 430. For example, public network 440 may interconnect external data authentication and event execution platforms 450, 460, government computing platform 470, user computing device 120, data feed aggregation server 495, and/or various other systems and/or devices.

In some arrangements, the computing device(s) that make up and/or are included in data authentication and event execution computing platform(s) 140, administrative computing device(s) 150, external data authentication and event execution platforms 450, 460, government platform 470, user computing device(s) 120, and data feed aggregation server(s) 495 may be any type of computing device capable of receiving a user interface, receiving input via the user interface, and communicating the received input to one or more other computing devices. For example, the computing device(s) that make up and/or are included in the platforms may, in some instances, be and/or include server computers, desktop computers, laptop computers, tablet computers, smart phones, or the like that may include one or more processors, memories, communication interfaces, storage device(s), and/or other components. As noted above, and as illustrated in greater detail below, any and/or all of the computing device(s) that make up and/or are included in the platforms may, in some instances, be special-purpose computing device(s) configured to perform specific functions

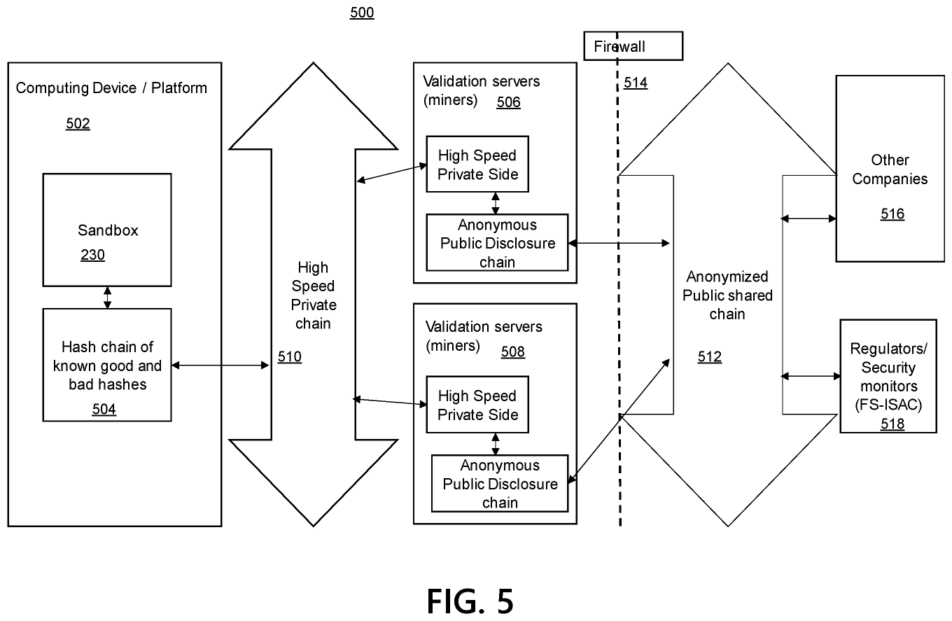

FIG. 5 illustrates an architecture in accordance with one or more embodiments for facilitating network transactions such as software validation, software versioning, malware-free certifications, malware reporting, monitoring, dissemination of secure information, digital rights management, and/or unauthorized copy detection, among others.

As referenced above, client and/or server device(s) and/or platform(s) 502 may store and/or implement their own sandbox(es) 230 to protect operating device(s) from unknown, untested, and/or potentially unsafe applications and/or code. Such devices may include one or more of data authentication and event execution computing platform(s) 140, administrative computing device(s) 150, external data authentication and event execution platforms 450, 460, or other devices in which safe testing or use of applications is desired. Hashes of known, authorized, authentic, malware-free, certified applications or code may be stored as “good” hashes in memory in one or more hash chain(s) 504. Similarly, hashes of known, unauthorized, inauthentic, malware containing, or uncertified applications or code may be stored as “bad” hashes in memory.

Client and/or server device(s) and/or platform(s) 502 may communicate with other such devices or with validation servers (such as miners) 506, 508 for the blockchain via a high-speed private chain 510, which may be internal within a company or organization. Validation servers 506, 508 may anonymize the results of good or bad hashes for corresponding applications, software, code, threat vectors, or the like, so as to remove company identification or attribution, if desired, and may share the information anonymously via an anonymized public shared chain 512 outside a company firewall 514. Other companies 516, government regulators 518, or the like may then access the information on the shared public chain 512 and may use the information to perform their own validation, testing, reporting, authenticating, certifying or other desired function. They may accomplish this by performing their own hashing of applications or code and then comparing those hash results with the known good and bad hashes. Similarly, the other companies may share their own known good and bad hashes for their own applications and code via the same process and with the same public chain 512.

For each new application or code detected by a computing device or software to be evaluated, the application or code may be hashed. The hash can be checked against an internal or public chain to see if it is known and, if so, if it is malicious. If the hash is unknown, it can be placed into the sandbox or virtual machine to check for malicious payloads or callouts etc. Malicious and non-malicious hashes can be put back onto the private (inter-company) high-speed chain 510 to share with the rest of the organization. As detailed above, validation servers (like miners) 506, 508 on the high-speed chain 510 have to have consensus to allow a new entry into the private chain. The validators also have a connection to an anonymous pubic chain 512 to share the known good and bad hashes with other like minded entities similar to FS-ISAC for banking or other regulators or monitoring agencies 518. This will allow businesses to disclose new bad hashes without attribution risk back that they are being targeted. The chain can be pre-seeded with hashes from vendors like VirusTotal and Avecto and with good hashes of known large patch pushes for commercial software and operating systems. Hashes of internally created apps can also be put on the chains to watch for the applications, code, scripts, or other files being taken to a competitor that is connected to the published side chain. This type of architecture allows regulators to monitor the chain for total industry scale events and anti-competitive behavior. Whitelisting of critical application updates may be stored on blockchains for reference and quick deployment as well.

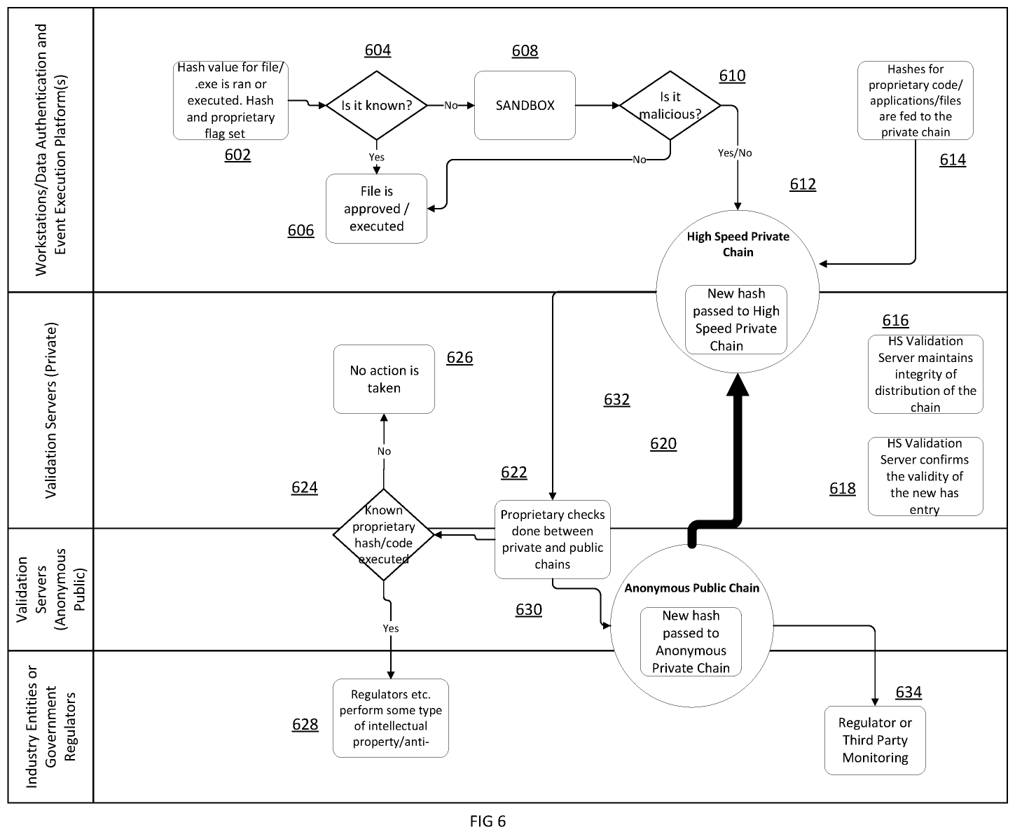

FIG. 6 depicts a sample flow diagram illustrating actions that can be performed by or on workstation(s), validation servers, highspeed private chain(s), anonymous public chain(s), as well as interactions with regulators or other third parties, in accordance with one or more embodiments.

When a new application, code, script, file or the like (collectively, “software”) is detected or selected for evaluation, a hash value for the software is ran or executed in step 602 and a hash and/or proprietary flag is set on a workstation, data authentication and event execution computer platform 140, other computing device 120, and/or administrative computing device 150. The hash is evaluated to determine whether the software is known or unknown in step 604. If the software is known, authentic, and/or authorized, the software is approved and/or executed in step 606.

If the software is unknown or requires testing, the software is copied to a sandbox or virtual machine and is executed in step 608. A determination is made in step 610 as to whether the software is malicious, unauthorized, modified or the like. If the software is safe, authorized, unmodified or the like, then the software is approved and/or executed in step 606. Otherwise, the hash for the malicious, unauthorized, modified or similar version of the software is fed to a high speed internal or private blockchain in step 612. Also, at any point before or during the process, hashes for software are seeded to the high-speed internal or private blockchain in step 614 and used for comparison purposes when evaluating hashes for software to be investigated or tested.

One or more high speed validation servers (miners) 506, 508 maintain the integrity of distribution of the chain in step 616 and confirm the validity of new hash entries in step 618. The validation servers can be private and/or public. Once validated, the new hash is passed to the anonymous public chain in step 620, and any changes detected on the anonymous public chain can propagated back to the high-speed private chain, if validated, in the same or similar step.

Propriety checks between private and public chains can be performed by validation servers in step 622. If hashes are known, authorized, authentic, or otherwise approved in step 624, the software may be executed, otherwise no action is taken in step 626. Otherwise, intellectual property and/or anti-counterfeiting authenticity evaluation may be performed by regulators or other third parties in step 628.

Results of propriety checks between private and public blockchains may be communicated to/from the private blockchain as in 632 or to/from the anonymous public chain as in 630

Regulators or other third parties may also monitor the anonymous public chain for reporting detected malware, unauthorized copying, unauthorized modifications of software or the like in step 634.

One or more aspects of the disclosure may be embodied in computer-usable data or computer-executable software or instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer-executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers, computing platforms, and/or one or more networks. The functionality may be distributed in any manner or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A software validation computing platform coupled to an anonymous public distributed ledger having a first public block and a second public block, the computing platform comprising:
a. at least one processor;
b. a communication interface communicatively coupled to the at least one processor and the anonymous public distributed ledger;
c. a private distributed ledger communicatively coupled to the communication interface;
d. memory, storing platform computer-readable instructions that, when executed by the at least one processor, cause the computing platform to:
i. generate, by the at least one processor, an authentic cryptographic hash of authentic software known to be malware free;
ii. store, in a first private block in the private distributed ledger, the authentic cryptographic hash corresponding to the authentic software and first indicia sufficient to identify the authentic software;
iii. anonymously store, in the first public block in the anonymous public distributed ledger, the authentic cryptographic hash corresponding to the authentic software and the first indicia sufficient to identify the authentic software;
iv. receive, from a data source, unknown software to be evaluated;
v. store, in a quarantine sector of the memory, the unknown software;
vi. load, from the first private block in the private distributed ledger to a first sector in the memory, the authentic cryptographic hash;
vii. generate, by the at least one processor, a test cryptographic hash of the unknown software;
viii. store, in a second sector of the memory, the test cryptographic hash corresponding to the unknown software;
ix. compare, by the at least one processor, the authentic cryptographic hash for the authentic software in the first sector of the memory to the test cryptographic hash for the unknown software in the second sector of the memory; and
x. if the authentic cryptographic hash and the test cryptographic hash match:
1. copy, from the quarantine sector of the memory to an authorized sector of the memory, the unknown software;
2. execute, by the at least one processor, the unknown software in the authorized sector of the memory;
xi. if the authentic cryptographic hash and the test cryptographic hash do not match:
1. copy, from the quarantine sector of the memory to a sandbox, the unknown software;
2. execute, by the at least one processor, the unknown software in the sandbox;
3. determine, by the at least one processor, whether the unknown software contains malware;
4. if the unknown software is malware free:
a. store, in a second private block in the private distributed ledger, the test cryptographic hash for the unknown software along with a certified event record that the unknown software is malware free and second indicia sufficient to identify the unknown software;
b. anonymously store, in the second public block in the anonymous public distributed ledger, the test cryptographic hash for the unknown software along with the certified event record that the unknown software is malware free and the second indicia sufficient to identify the unknown software;
c. copy, from the quarantine sector of the memory to the authorized sector of the memory, the unknown software;
d. execute, by the at least one processor, the unknown software in the authorized sector of the memory;
e. if the unknown software contains malware:
i. store, in the second private block in the private distributed ledger, the test cryptographic hash for the unknown software along with an uncertified event record that the unknown software contains malware and the second indicia sufficient to identify the unknown software;
ii. anonymously store, in the second public block in the anonymous public distributed ledger, the test cryptographic hash for the unknown software along with an uncertified event record that the unknown software contains malware and the second indicia sufficient to identify the unknown software; and
iii. prevent, by the at least one processor, execution of the unknown software outside of the quarantine sector of the memory.

2. The software validation computing platform of claim 1 further comprising a plurality of validation servers each having:
a. at least one validation processor;
b. a validation communication interface communicatively coupled to the at least one validation processor and the private distributed ledger; and
c. a validation memory storing validation computer-readable instructions that, when executed by the at least one validation processor, cause the validation software to:
i. independently validate, by the at least one validation processor, the test cryptographic hash prior to the anonymous storing of the test cryptographic hash in the second public block of the anonymous public distributed ledger;
ii. determine, by the at least one validation processor in response to the independent validation, whether a majority of the plurality of validation servers agree that the test cryptographic hash is valid; and
1. if the plurality of validation servers agree that the test cryptographic hash is valid:
a. store, in a second private block in the private distributed ledger, the test cryptographic hash for the unknown software along with a certified event record that the unknown software is malware free and second indicia sufficient to identify the unknown software;
b. anonymously store, in the second public block in the anonymous public distributed ledger, the test cryptographic hash for the unknown software along with the certified event record that the unknown software is malware free and the second indicia sufficient to identify the unknown software; and
2. if the plurality of validation servers do not agree that the test cryptographic has is valid, disregard, by the at least one validation processor, the test cryptographic hash.

3. The software validation computing platform of claim 2 wherein the comparison, by the at least one processor, of the authentic cryptographic hash for the authentic software in the first sector of the memory to the test cryptographic hash for the unknown software in the second sector of the memory determines if the unknown software is an unauthorized copy of the authentic software.

4. The software validation computing platform of claim 2 further comprising a firewall protecting the private distributed ledger from the anonymous distributed ledger.

5. The software validation computing platform of claim 2 further comprising a firewall protecting the private distributed ledger and at least one of the plurality of validation servers from the anonymous public distributed ledger.

6. The software validation computing platform of claim 2 further comprising a firewall protecting the private distributed ledger and at least one of the plurality of validation servers from the anonymous public distributed ledger and at least another of the plurality of validation servers.

7. The software validation computing platform of claim 4 wherein the plurality of validation servers are full node computing devices.

8. The software validation computing platform of claim 4 wherein at least one of the plurality of validation servers is a full node computing device and at least another of the plurality of validation servers is a lightweight computing device.

9. The software validation computing platform of claim 4 wherein the sandbox is a virtual machine.

10. The software validation computing platform of claim 4 wherein the test cryptographic hash for the unknown software is stored, in the second private block in the private distributed ledger, along with either the certified event record or the uncertified event record, the second indicia sufficient to identify the unknown software, and a generic numeric representation of the private distributed ledger.

11. The software validation computing platform of claim 4 wherein the test cryptographic hash for the unknown software is anonymously stored, in the second public block in the anonymous public distributed ledger, along with either the certified event record or the uncertified event record, the second indicia sufficient to identify the unknown software, and a generic numeric representation of the anonymous public distributed ledger.

12. The software validation computing platform of claim 10 wherein the generic numeric representation of the private distributed ledger comprises a 256-bit hexadecimal number.

13. The software validation computing platform of claim 11 wherein the generic numeric representation of the anonymous public distributed ledger comprises a 256-bit hexadecimal number.

14. One or more non-transitory computer-readable media storing instructions that, when executed by a software validation computing platform comprising a plurality of processors communicatively coupled to at least one communication interface, which is communicatively coupled to said one or more computer-readable media, to a private distributed ledger and to an anonymous public ledger, cause the computing platform to:
a. generate, by a first of the plurality of processors, an authentic cryptographic hash of authentic software known to be malware free;
b. store, in a first private block in the private distributed ledger, the authentic cryptographic hash corresponding to the authentic software and first indicia sufficient to identify the authentic software;
c. validate, by the plurality of processors, the authentic cryptographic hash;
d. determine, by the plurality of processors, whether a first majority of the plurality of processors agree that the authentic cryptographic hash is valid, and, if valid:
i. store, in a first private block in the private distributed ledger, the authentic cryptographic hash for the authentic software along with a first certified event record that the authentic software is malware free and first indicia sufficient to identify the authentic software; and
ii. anonymously store, in a first public block in the anonymous public distributed ledger, the authentic cryptographic hash for the authentic software along with the first certified event record that the authentic software is malware free and the first indicia sufficient to identify the authentic software;
e. receive, from a data source, unknown software to be evaluated;
f. store, in a quarantine sector of said one or more computer-readable media, the unknown software;
g. generate, by the first of the plurality of processors, a test cryptographic hash of the unknown software;
h. compare, by the first of the plurality of processors, the authentic cryptographic hash with the test cryptographic hash;
i. if the authentic cryptographic hash and the test cryptographic hash match:
i. copy, from the quarantine sector of the at least one computer-readable media to an authorized sector of the at least one computer-readable media, the unknown software;
ii. authorize, by the first of the plurality of processors, execution of the unknown software;
j. if the authentic cryptographic hash and the test cryptographic hash do not match:
i. copy, from the quarantine sector of the at least one computer-readable media to a sandbox, the unknown software;
ii. execute, by the first of the plurality of processors, the unknown software in the sandbox;
iii. determine, by the first of the plurality of processors, whether the unknown software contains malware;
iv. if the unknown software is malware free:
1. store, in a second private block in the private distributed ledger, the test cryptographic hash for the unknown software along with a second certified event record that the unknown software is malware free and second indicia sufficient to identify the unknown software;
2. validate, by the plurality of processors, the test cryptographic hash;
3. determine, by the plurality of processors, whether a second majority of the plurality of processors agree that the test cryptographic hash is valid, and, if valid:
a. store, in a second private block in the private distributed ledger, the test cryptographic hash for the unknown software along with the second certified event record that the authentic software is malware free and second indicia sufficient to identify the unknown software;
b. anonymously store, in the second public block in the anonymous public distributed ledger, the test cryptographic hash for the unknown software along with the second certified event record that the unknown software is malware free and the second indicia sufficient to identify the authentic software;
v. if the unknown software contains malware:
1. validate, by the plurality of processors, the test cryptographic hash; and
2. determine, by the plurality of processors, whether a third majority of the plurality of processors agree that the test cryptographic hash is valid, and, if valid:
a. store, in the second private block in the private distributed ledger, the test cryptographic hash for the unknown software along with an uncertified event record that the unknown software contains malware and the second indicia sufficient to identify the unknown software; and
b. anonymously store, in the second public block in the anonymous public distributed ledger, the test cryptographic hash for the unknown software along with the uncertified event record that the unknown software contains malware and the second indicia sufficient to identify the authentic software.

15. The computer-readable media of claim 14 wherein the test cryptographic hash for the unknown software is stored, in the second private block in the private distributed ledger, along with either the certified event record or the uncertified event record, the second indicia sufficient to identify the unknown software, and a private generic numeric representation of the private distributed ledger.

16. The computer-readable media of claim 15 wherein the test cryptographic hash for the unknown software is anonymously stored, in the second public block in the anonymous public distributed ledger, along with either the certified event record or the uncertified event record, the second indicia sufficient to identify the unknown software, and a public generic numeric representation of the anonymous public distributed ledger.

17. The computer-readable media of claim 16 wherein the private generic numeric representation of the private distributed ledger and the public generic numeric representation of the anonymous public distributed ledger are comprised of 256-bit hexadecimal numbers.

18. The computer-readable media of claim 17 wherein the sandbox is a virtual machine.

19. A dual blockchain software validation method comprising the steps of:
a. storing, by a software validation platform in a first private block in a private distributed ledger, an authentic cryptographic hash corresponding to authentic software known to be malware free and first indicia sufficient to identify the authentic software;
b. storing, by the software validation platform in a first public block in an anonymous public distributed ledger, the authentic cryptographic hash corresponding to the authentic software and the first indicia sufficient to identify the authentic software;
c. receiving, by the software validation platform from a data source, unknown software to be evaluated;
d. storing, in a quarantine sector of memory in the software validation platform, the unknown software;
e. hashing, by the software validation platform, a test cryptographic hash for the unknown software;
f. comparing, by the software validation platform, the test cryptographic hash to the authentic cryptographic hash;
g. if the authentic cryptographic hash and the test cryptographic hash match:
i. copying, by the software validation platform from the quarantine sector of the memory to an authorized sector of the memory, the unknown software;
ii. authorizing, by the software validation platform, execution of the unknown software;
h. if the authentic cryptographic hash and the test cryptographic hash do not match:
i. copying, by the software validation platform from the quarantine sector of to a sandbox, the unknown software;
ii. executing, by the software validation platform, the unknown software in the sandbox;
iii. determining, by the software validation platform, whether the unknown software contains malware;
iv. if the unknown software is malware free:
1. validating, by a plurality of processors in the software validation platform, the test cryptographic hash;
2. determining, by the plurality of processors, whether a first majority of the plurality of processors agree that the test cryptographic hash is valid, and, if valid:
a. storing, by the software validation platform in a second private block in the private distributed ledger, the test cryptographic hash for the unknown software along with a second certified event record that the unknown software is malware free and second indicia sufficient to identify the unknown software;
b. anonymously storing, by the software validation platform in the second public block in the anonymous public distributed ledger, the test cryptographic hash for the unknown software along with the second certified event record that the unknown software is malware free and the second indicia sufficient to identify the authentic software;
c. copying, by the software validation platform from the quarantine sector of the memory to the authorized sector of the memory, the unknown software;
d. authorizing, by the software validation platform, execution of the unknown software; and
v. if the unknown software contains malware:
1. validating, by the plurality of processors in the software validation platform, the test cryptographic hash;
2. determining, by the plurality of processors, whether a second majority of the plurality of processors agree that the test cryptographic hash is valid, and, if valid:
a. storing, by the software validation platform in the second private block in the private distributed ledger, the test cryptographic hash for the unknown software along with an uncertified event record that the unknown software is contains malware and the second indicia sufficient to identify the unknown software;
b. anonymously storing, by the software validation platform in the second public block in the anonymous public distributed ledger, the test cryptographic hash for the unknown software along with the uncertified event record that the unknown software is contains malware and the second indicia sufficient to identify the authentic software; and
3. deleting, by the software validation platform from the sandbox, the unknown software.

20. The dual blockchain software validation method of claim 19 wherein the comparison, by the software validation platform, of the test cryptographic hash to the authentic cryptographic hash determines if the unknown software is an unauthorized copy of the authentic software.
